(19) United States
(12) Patent Application Publication
(10) Pub. No.: US 2009/0162809 A1
(43) Pub. Date: Jun. 25, 2009

(54) Apparatus for positioning dental impression molds

(76) Inventor: Matthew J. Tuohy, Kent, WA (US)

Correspondence Address: Matthew J. Tuohy, P.O. Box 785, Kent, WA, 98035, US

(21) Appl. No.: 11/980,903

(22) Filed: Oct. 31, 2007

(51) Int. Cl. A61C 9/00

(52) U.S. Cl. 433/44

(57) ABSTRACT

A dental impression alignment guide comprising a frame which holds a conventional dental impression compound tray on one end and a laser source on the other end. The laser beam is split into two orthogonal fan shaped beams that project vertical and horizontal lines on the face of a patient. The lines are fixedly coupled to the impression compound tray, thus indicate the tray's position in the patient's mouth. The use of the alignment measuring tool facilitates the alignment of subsequent dentures in the articulated artificial jaw dentists use to verify fit and occlusion before moving dentures, appliances, or surgical procedures to the patient.

### RELATED APPLICATION

Applicant claims priority based on Provisional application Ser. No. 06/855,593, By the above name inventor and Filed on Oct. 31, 2006. Titled: Apparatus for Leveling Dental Impression Molds, and incorporates above described Provisional Application herein by reference.

### U.S. GOVERNMENT INTEREST IN THE INVENTION

None

### BACKGROUND OF THE INVENTION

1. Field of the Invention

This invention is a tool for aligning dental impression molds relative to the vertical median of a patients face utilizing projected light onto the patient's face as a marking and guide means.

2. Description of Related Art

Current art is best described in U.S. Pat. No. 6,582,931 by John C. Kois DDS. A impression cup carrying dental impression compound is mounted to a flat carrier also having a 6 to 8 inch vertical post a few inches outwardly from the cup. The cup is placed in the patients mouth as usual. The dentist then sights beyond the post, aligning the post's image with the patients forehead and center of the nose, lips, etc. The patient then gently bites down into the impression compound, leaving a mold of his teeth. Or at minimum, an impression of the distal ends of the teeth in the arch. From these, the dentist can measure the relative position and protrusion of each tooth for setting new teeth into the same vertical alignment as the natural teeth. And to calibrate and align the mechanical jaw dentists use to “try out” a set of artificial teeth before installing them in the patients mouth. The prior art suffers from a parallax problem creating uncertainty with the perceived alignment of the post and face. It also shows no horizontal alignment.

3. Objects of the invention

It is an object of the invention to project alignment markings onto the face of a dental patient for the purpose of making “as built” measurements of the natural teeth, mandible, and upper jaw alignments.

It is another object of the invention to have the projected markings visible in the brightly fit dental operating theater.

### BRIEF SUMMARY OF THE INVENTION

A dental impression alignment guide comprising a frame which holds a conventional dental impression compound tray on one end and a projector of a columnated light beam on the other end. The beam, usually from a laser diode is split by a prismatic lens into two orthogonal fan shaped beams that project vertical and horizontal lines on the face of a patient. Alternatively, two columnated beams can each be spread into a fan shaped beam by a prism. The lines projected by the two fan shaped beams are then set in orthogonal relationship and draw the same orthogonal pair of lines as the double prism does with a single columnated beam. The lines are fixedly coupled to an impression compound tray, thus indicate the tray's position in the patient's mouth.

The use of the alignment measuring tool facilitates the alignment of subsequent dentures in the articulated artificial jaw dentists use to verify fit and occlusion before moving dentures, appliances, or surgical procedures to the patient.

### BRIEF DESCRIPTION OF THE FIGURES

FIG. 1 is an overall view of the invention

FIG. 2 is the carrier for a mold tray

FIG. 3 is a diagram of the optics

FIG. 4 is a facial view showing the projected guide lines on a f

FIG. 5 is a side view showing the invention in use.

### TABLE OF IDENTIFIED DETAILS

1. The tool overall view
2. Calibrated sliding mount
3. Optics housing
4. Slider slot
5. Alignment bracket
6. Alignment slot
7. Alignment pegs in slot 6
8. Calibrated scale
9. Laser light port (light source inside)
20. Tang portion of the dental cup holder
21. Alignment slot in holder
22. Dental cup tray
23. Cup holder mounting.
30. Laser
32. Prismatic element, refracting grid
33. Optical attenuator
34 Angle of extent of horizontal beam
35. Battery and ballast resistor or circuitry
36. On-off switch
40. Projected vertical marking beam
41. Projected horizontal marking beam
42. Usage diagrams

### DETAILED DESCRIPTION OF THE INVENTION

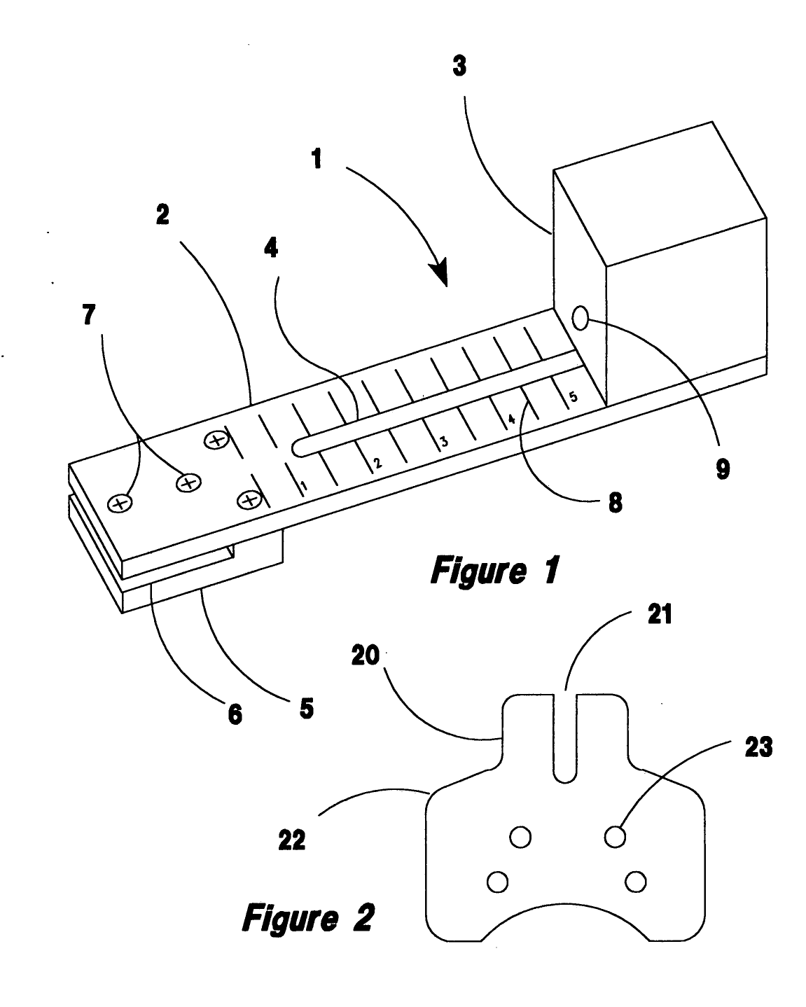

Referring to FIG. 1, the overall alignment tool designated as item 1 comprises a frame 2, light beam projector 3, adjustment slot 4, tray carrier attachment means 5, 6, 7, and a scale 8. The slot 4 also provides passage for the fan beam to project below the frame.

The attaching means for the mold tray (Also see FIG. 2) comprises bottom lip 5, slot 6, and alignment posts 7. The tang 20 of the tray 22 has a slot 21. The slot straddles guide pins 7 and slot 6 holds the tang 20 by friction.

The back edge of tang 20 and slot 21, holds compound holder tray 22 precisely in a standardized position, ready to be aligned with the patient's face 42 and ready to take the impression.

Holes 23 are for precisely mounting the dental impression compound tray.

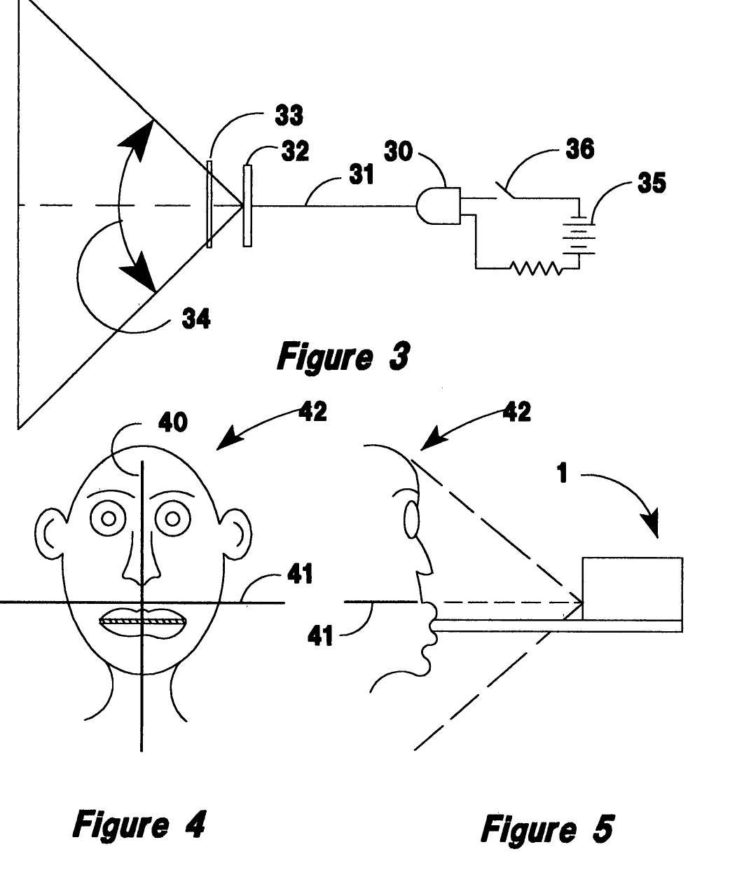

Referring to FIG. 3, the optics comprise a light source 30 emitting a beam 31, a prismatic element 32 that re-forms the beam into two orthogonal fan shaped beams, and an attenuator 33 to reduce the beam intensity as much as can be done while still projecting adequately bright lines on the patient's face. The fan beams expand at an angle 34 calibrated so that the scale 8 on the frame indicates the length of the upper, lower, left and right extent of the fan beams. The preferred angle 34 is 90 degrees.

The optics housing 3 contains the optical elements and necessary associated parts such as batteries and current regulating electronics 35, on-off switch 36, and beam orifice 9.

The figures and foregoing text describe a single columnated beam being prismatically split into two orthogonal fans to project two orthogonal lines on the patient's face. The same results can be accomplished by using two columnated beams and 2 dimensional prisms set at 90 degrees apart. Prisms adapted to produce a single fan shaped beam and subsequent projected line should be more readily available and lower cost than the more complex double prism. The beam projecting diodes and prism sets can be set alongside each other or one above the other as long as together they can be adjusted to project the described orthogonal lines on the face. The preferred arrangement for the projectors is to have the horizontal projector set in vertical alignment just over the vertical projector.

### ALTERNATIVE EMBODIMENTS AND VARIATIONS OF THE INVENTION

Frame 2 could be made of transparent material to permit the beam to pass through, However, the index of refraction, and any scratches would distort the beam some, and would also produce a reflection possibly causing a multiple set of lines on the upper portion of the patients face. These minor drawbacks probably would not be not enough to render the invention inoperative. When slot 4 is not used in the frame, beam projector 3 has side clamps to adjust and secure it to frame 2.

There is no requirement for the beam to be coherent light or that it be any particular color. Red laser diodes are small size, use low voltages and low power, and are suitable and readily available.

The light source and prism used at present is removed from a Bushnell framing and leveling square. Both should be readily available from their respective OEM supply sources.

It is possible to eliminate the prism(s) by mounting the diodes on pivots then swinging them back and forth and up and down so the projected dots traverse the orthogonal courses. The beams can be moved manually with measurements taken at the various critical positions. Orthogonal pivots on a single laser diode will also work. Obviously such pivots will have to be interlocked so only one axis swings at a time to avoid tracing a circle or oval.

However, in order to project a line as before, the diodes should be moved rapidly, at least 14 cycles per second on each axis, which will be perceived as a line or lines.

Pivot able projectors are capable of tracing a grid or scaled “tick marks” on the primary XY lines.

### How to Use the Invention

The patient is fitted with protective eye wear, either filters, or opaque goggles for protection against the unlikely prospect of being “flashed” with bright light from the laser.

The impression compound is put into a standard mouth mold and mounted on the mold tray. The tray is attached to the frame and put into the patient's mouth. The beam is projected onto the patient's face vertically, and horizontally approximately at the lip line. When the dentist is satisfied with the positioning of the alignment lines, an impression taken of as much of the tooth arch as is needed.

The foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to falling within the scope of the invention as defined by the claims which follow.

The embodiments of the invention in which an exclusive property right or privilege is claimed are defined as follows:

I claim:

1. An alignment tool for setting the position of a dental impression molding tray and compound within a patient's mouth comprising:
a. an elongated frame having upper and lower essentially flat and parallel surfaces, and on one end, means to removably attach an adapter for holding a dental impression cup, and on the opposite end, means for slidably attaching a light beam projecting means, and
b. a light beam comprising a first fan shaped beam oriented perpendicular to the upper surface of said frame, and a second fan shaped beam oriented parallel to the upper surface of said frame, whereby
c. when the light beam projecting means is operating and the impression cup is within the patient's mouth, the light beam projecting means projects orthogonal traces of light onto the face of the patient, said traces are in alignment with the said impression cup thereby indicating the orientation of said cup in relation to the patient's face.

2. The alignment tool of claim 1 further comprising said frame having longitudinally oriented slot allowing passage of said perpendicular beam through said frame.

3. The alignment tool of claim 1 where the frame is transparent to permit passage of said perpendicular beam through the frame.

4. The alignment tool of claim 1 further comprising a frame having a scale, whereby said scale in cooperation with the spreading angle of said orthogonal fan shaped beams indicates the length of the lines projected by the fan shaped beams.

5. The alignment tool of claim 1 further comprising a power source to energize said light beam projecting means, and an operator controlled switch to turn said light beam projecting means on and off.

6. An alignment tool for setting the position of a dental impression molding tray and compound within a patient's mouth comprising:
a. an elongated frame having upper and lower essentially flat and parallel surfaces, and on one end, attachment means to removably attach an adapter for holding an impression cup, and on the opposite end, a slot and attachment means for slidably attaching a light beam projecting means, and
b. a projected light beam comprising first a fan shaped beam oriented perpendicular to the upper surface of said frame, and a second fan shaped beam oriented parallel to the upper surface of said frame, whereby
c. when the light beam means is operating and the impression cup is within the patient's mouth, said light beam means projects orthogonal traces of light onto the face of the patient, said traces are in alignment with the said impression cup thereby indicating the orientation of said cup in relation to the patient's face.

7. The alignment tool of claim 6 where the light beam projecting means is a laser diode cooperatively coupled to a prism mean which diffuses the beam from the laser diode into orthogonal fan shaped beams, and a cooperating power source to energize said diode, and an operator controlled switch for turning the light beam on and off.

8. The alignment tool of claim 6 further comprising an attenuator means to diminish the intensity of said orthogonal fan shaped beams.

9. The alignment tool of claim 6 further comprising a scale whereby said scale in cooperation with the spreading angle of said orthogonal fan shaped beams indicates the length of the lines projected by the fan shaped beams.
